(19) United States
(12) Patent Application Publication
(10) Pub. No.: US 2024/0168147 A1
(43) Pub. Date: May 23, 2024

(54) METHOD AND APPARATUS FOR DETERMINING LOCATION USING PHASE DIFFERENCE OF ARRIVAL

(71) Applicant: Decawave, Ltd., Dublin (IE)

(72) Inventors: Michael McLaughlin, Dublin (IE); Gavin Marrow, Dublin (IE); Igor Dotlic, Dublin (IE)

(21) Appl. No.: 18/418,753

(22) Filed: Jan. 22, 2024

Related U.S. Application Data
(63) Continuation of application No. 17/856,591, filed on Jul. 1, 2022, now Pat. No. 11,921,185.
Application No. 17/856,591 is a continuation of application No. 16/352,372, filed on Mar. 13, 2019, now abandoned.
Application No. 16/352,372 is a division of application No. 15/974,412, filed on May 8, 2018, now Pat. No. 10,509,116.
(60) Provisional application No. 62/663,122, filed on Apr. 26, 2018.

(51) Int. Cl. G01S 13/02; G01S 3/02; G01S 3/48

(52) U.S. Cl. CPC G01S 13/0209; G01S 3/023; G01S 3/48

(57) ABSTRACT

Embodiments of an ultra-wideband (UWB) transceiver are disclosed. The UWB transceiver includes a transmitter and a receiver. The receiver has a first antenna and a second antenna. The first antenna and the second antenna are separated by a first distance, d. The receiver is configured to use the first antenna to receive the transmitted signal and use the second antenna to receive the transmitted signal, develop a range, r, between the transmitter and a selected one the first and second antennas, and develop a path difference value, p, develop an (x, y) location of the transmitter relative to the receiver as a function of d, r, and p.

### RELATED APPLICATIONS

This application is a continuation of U.S. patent application Ser. No. 17/856,591, filed Jul. 1, 2022, which is a continuation of U.S. patent application Ser. No. 16/352,372, filed Mar. 13, 2019, which is a divisional of U.S. patent application Ser. No. 15/974,412, filed May 8, 2018, now U.S. Pat. No. 10,509,116, which claims the benefit of provisional patent application Ser. No. 62/663,122, filed Apr. 26, 2018, the disclosures of which are hereby incorporated herein by reference in their entireties.

The subject matter of this application is also related to the subject matter of International Application No. PCT/EP2014/060722, filed May 23, 2014, and U.S. patent application Ser. No. 15/375,739, filed Dec. 12, 2016, pursuant to 37 CFT § 1.78(a)(4).

### FIELD OF THE DISCLOSURE

The present invention relates generally to ultra-wideband communication systems, and, in particular, to a receiver for use in an ultra-wideband communication system adapted to determine the location of an RF transmitter relative to an RF receiver.

### BACKGROUND

In general, in the descriptions that follow, we will italicize the first occurrence of each special term of art which should be familiar to those skilled in the art of ultra-wideband (UWB) communication systems. In addition, when we first introduce a term that we believe to be new or that we will use in a context that we believe to be new, we will bold the term and provide the definition that we intend to apply to that term. In additional, throughout this description, we will sometimes use the terms “assert” and “negate” when referring to the rendering of a signal, signal flag, status bit, or similar apparatuses into its logically true or logically false state, respectively, and the term “toggle” to indicate the logical inversion of a signal from one logical state to the other. Alternatively, we may refer to the mutually exclusive Boolean states as logic_0 and logic_1. Of course, as is well known, consistent system operations can be obtained by reversing the logic sense of all such signals, such that signals described herein as “logically true” become logically false and vice versa. Furthermore, it is of no relevance in such systems which specific voltage levels are selected to represent each of the logic states.

In the RF system topology shown in FIG. 1, it can be seen that, because of the nonzero angle of incidence, ⊖, the RF signal, will arrive at one antenna before the other. In particular, it can be seen that the path to antenna A is greater than to antenna B by p=d*sin θ. In order to calculate ⊖, the angle of incidence, the time difference of arrival could be found. If d is relatively large, then this would provide quite an accurate estimate of e. On the other hand, if d is small, the estimate turns out to be highly error prone.

FIG. 2 shows two receivers, 10a and 10b, which are clocked from the same FIG. 2 shows two receivers, 10a and 10b, which are clocked from the same crystal 12. If the same crystal 12 clocks identical phase locked loops (PLLs), 14a and 14b, the generated carriers that are supplied to the respective down converter mixers, 16ac-16as and 16bc-16as, will have the same phase. The RF signal will arrive at a slightly later time at antenna A than antenna B, so it will encounter a down converter carrier phase this is different in each of the mixers 16. If the baseband processors, 18a and 18b, are capable of calculating the complex impulse response of the channel, that impulse response will have a different in-phase (I) to quadrature (Q) ratio I/O, which is equal to the phase delay caused by the signal travelling the extra distance, p, before encountering the mixer 10a and being down-converted by the carrier. If the carrier frequency is high, e.g., 5 GHz or 6.5 GHz, then quite small distances, p, will lead to a relatively large carrier phase difference:

$$sin θ = \frac{P}{d} \qquad [ Eq . 1 ]$$

$$λ = \frac{c}{f} \qquad [ Eq . 2 ]$$

where:
f is the carrier frequency;
c is the speed of light; and
λ is the carrier wavelength.

$$\frac{a}{2 π} = \frac{P}{λ} \qquad [ Eq . 3 ]$$

where:
α is the phase difference between the two carriers for the same point on the incident RF signal

$$\begin{matrix}( From Eq . 2 and Eq . 3 ) & \\ p = \frac{a λ}{2 π} & [ Eq . 4 ]\end{matrix}$$

$$\begin{matrix}( From Eq . 1 and Eq . 4 ) & \\ sin ∅ = \frac{a λ}{2 π d} & [ Eq . 5 ]\end{matrix}$$

$$\begin{matrix}( From Eq . 5 ) & \\ ∅ = {sin}^{- 1} ( \frac{a λ}{2 π d} ) & [ Eq . 6 ]\end{matrix}$$

Many angle-of-arrival (AoA) estimators require the use of multiple receivers, each listening to its own antenna, see, e.g., the First Related Application. In some AoA estimators, a single receiver is electronically switched between a plurality of antennas, see, e.g., the Second Related Application. In all such embodiments, the AoA approach tends to be problematic. In the Second Related Reference, several possible solutions are proposed.

Using two or more receiver antennas, the location of a transmitter can be found by using the time of flight to get the distance to the transmitter and using the difference in either the time of arrival or phase of arrival to calculate an angle of arrival. However, we submit that it is unnecessary to calculate the angle of arrival in order to find that location. Further, we submit that what is needed in an improved method and apparatus for use in the receiver of a UWB communication system to determine the (x,y) location of a transmitter with respect to a receiver. In particular, we submit that such a method and apparatus should provide performance generally comparable to the best prior art techniques but more efficiently than known implementations of such prior art techniques.

### SUMMARY

In some embodiments, an ultra-wideband (UWB) transceiver, includes a transmitter; a receiver having a first antenna and a second antenna separated by a first distance, d; a non-transitory computer readable medium configured to store computer executable instructions; one or more processors, wherein, in response to executing the computer executable instructions, the one or more processors are configured to perform a method includes the steps of: using the first antenna to receive the transmitted signal; using the second antenna to receive the transmitted signal; and using the receiver to: develop a range, r, between the transmitter and a selected one of the first and second antennas; develop a first time of flight value as a function of the complex baseband impulse response of the transmitted signal received by the first antenna; develop a second time of flight value as a function of the complex baseband impulse response of the transmitted signal received by the second antenna; develop a path difference value, p, as a function of the first and second time of flight values; and develop an (x, y) location of the transmitter relative to the receiver as a function of d, r and p. In some embodiments, d is less than or equal to one half a wavelength, λ, of the transmitted signal. In some embodiments, the processor is configured to develop the path difference value, p, as the function of the first and second phase values by developing a path difference value, p, as a function of the first and second time of flight values and of a selected calibration function.

In some embodiments, an ultra-wideband (UWB) receiver, includes: a first antenna; a second antenna separated by a first distance, d; a non-transitory computer readable medium configured to store computer executable instructions one or more processors, wherein, in response to executing the computer executable instructions, the one or more processors are configured to perform a method includes the steps of: using the first antenna to receive the transmitted signal; using the second antenna to receive the transmitted signal; and using the receiver to: develop a range, r, between the transmitter and a selected one of the first and second antennas; develop a first time of flight value as a function of the complex baseband impulse response of the transmitted signal received by the first antenna; develop a second time of flight value as a function of the complex baseband impulse response of the transmitted signal received by the second antenna; develop a path difference value, p, as a function of the first and second time of flight values; and develop an (x, y) location of the transmitter relative to the receiver as a function of d, r and p. In some embodiments, d is less than or equal to one half a wavelength, λ, of the transmitted signal. In some embodiments, the processor is configured to develop the path difference value, p, as the function of the first and second phase values by developing a path difference value, p, as a function of the first and second time of flight values and of a selected calibration function.

In some embodiments, an ultra-wideband (UWB) transceiver, includes: a transmitter; a receiver includes a first antenna and a second antenna; a non-transitory computer readable medium configured to store computer executable instructions; one or more processors, wherein, in response to executing the computer executable instructions, the one or more processors are configured to perform a method includes the steps of: developing a range between the transmitter of a transmitted signal and one of: the first antenna of the receiver that received the transmitted signal; or the second antenna of the receiver that received the transmitted signal; developing a first phase value as a function of a complex baseband impulse response of the transmitted signal received at the first antenna; developing a second phase value as a function of a complex baseband impulse response of the transmitted signal received at the second antenna developing a path difference value as a function of the first phase value and the second phase value; and developing a location of the transmitter relative to the receiver as a function of the range, the path difference value, and a distance between the first antenna and the second antenna. In some embodiments, the processor is further configured to: receive the transmitted signal from the first antenna of the receiver; and receive the transmitted signal from the second antenna of the receiver. In some embodiments, the distance is less than or equal to one half of a wavelength of the transmitted signal. In some embodiments, developing the path difference value as the function of the first phase value and the second phase value includes developing the path difference value as a function of the first phase value and the second phase value and a calibration function.

In some embodiments, an ultra-wideband (UWB) receiver, includes: a first antenna; a second antenna; a non-transitory computer readable medium configured to store computer executable instructions; one or more processors, wherein, in response to executing the computer executable instructions, the one or more processors are configured to perform a method includes the steps of: developing a range between a transmitter of a transmitted signal and one of: the first antenna of the receiver that received the transmitted signal; or the second antenna of the receiver that received the transmitted signal; developing a first phase value as a function of a complex baseband impulse response of the transmitted signal received at the first antenna; developing a second phase value as a function of a complex baseband impulse response of the transmitted signal received at the second antenna; developing a path difference value as a function of the first phase value and the second phase value; and developing a location of the transmitter relative to the receiver as a function of the range, the path difference value, and a distance between the first antenna and the second antenna. In some embodiments, the processor is further configured to: receive the transmitted signal from the first antenna of the receiver; and receive the transmitted signal from the second antenna of the receiver. In some embodiments, the distance is less than or equal to one half of a wavelength of the transmitted signal. In some embodiments, developing the path difference value as the function of the first phase value and the second phase value includes developing the path difference value as a function of the first phase value and the second phase value and a calibration function.

In some embodiments, an ultra-wideband (UWB) transceiver, includes a transmitter; a receiver includes a first antenna and a second antenna, wherein the first antenna and the second antenna are separated by a first distance, d; a non-transitory computer readable medium configured to store computer executable instructions; one or more processors, wherein, in response to executing the computer executable instructions, the one or more processors are configured to perform a method includes the steps of: using the first antenna to receive the transmitted signal; using the second antenna to receive the transmitted signal; and using the receiver to: develop a range, r, between the transmitter and a selected one the first and second antennas; develop a first value as a function of the complex baseband impulse response of the transmitted signal received by the first antenna; develop a second value as a function of the complex baseband impulse response of the transmitted signal received by the second antenna; develop a path difference value, p, as a function of the first and second values; and develop an (x, y) location of the transmitter relative to the receiver as a function of d, r, and, p. In some embodiments, each of the first and second values is further characterized as a phase value. In some embodiments, each of the first and second values is further characterized as a time of arrival value. In some embodiments, each of the first and second values is further characterized as a time of flight value. In some embodiments, each of the first and second values is a selected one of a phase value, a time of arrival value and a time of flight value.

In some embodiments, an ultra-wideband (UWB) receiver, includes: a first antenna; a second antenna, wherein the first antenna and the second antenna are separated by a first distance, d; a non-transitory computer readable medium configured to store computer executable instructions; one or more processors, wherein, in response to executing the computer executable instructions, the one or more processors are configured to perform a method includes the steps of: using the first antenna to receive the transmitted signal; using the second antenna to receive the transmitted signal; and develop a range, r, between a transmitter and a selected one the first and second antennas; develop a first value as a function of the complex baseband impulse response of the transmitted signal received by the first antenna; develop a second value as a function of the complex baseband impulse response of the transmitted signal received by the second antenna; develop a path difference value, p, as a function of the first and second values; and develop an (x, y) location of the transmitter relative to the receiver as a function of d, r, and, p. In some embodiments, each of the first and second values is further characterized as a phase value. In some embodiments, each of the first and second values is further characterized as a time of arrival value. In some embodiments, each of the first and second values is further characterized as a time of flight value. In some embodiments, each of the first and second values is a selected one of a phase value, a time of arrival value and a time of flight value.

The methods of our invention may be embodied in non-transitory computer readable code on a suitable computer readable medium such that, when a processor executes the computer readable code, the processor executes the respective method.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1 illustrates, generally, in a topographic perspective, an RF communication system, and, in particular, the different angles of incidence of the transmitted RF signal on two antennas spaced apart by a distance d;

FIG. 2 illustrates, in a block diagram form, the antennas of FIG. 1, together with the respective RF receivers;

FIG. 3 illustrates, in a block diagram form, one application of our invention to determine the location of a transmitter relative to a multi-antenna receiver;

FIG. 4 illustrates, in chart form, the relationship between range and phase difference for an antenna separation of λ/2 using a single carrier;

FIG. 5 illustrates, in flow diagram form, a phase difference embodiment of a method adapted for use in the embodiment set forth in FIG. 3;

FIG. 6 illustrates, in flow diagram form, a time of arrival difference embodiment of a method adapted for use in the embodiment set forth in FIG. 3;

FIG. 7 illustrates, in flow diagram form, a time of flight difference embodiment of a method adapted for use in the embodiment set forth in FIG. 3;

FIG. 8 illustrates, in chart form, the relationship between range and phase difference for an antenna separation greater than λ/2 using a single carrier;

FIG. 9 illustrates, in chart form, the relationship between range and phase difference for the same antenna separation as in FIG. 8, i.e., greater than λ/2, but using a different carrier than in FIG. 8;

FIG. 10 illustrates, in chart form, one example of a correction function for compensating for path distortion resulting from real world effects; and

FIG. 11, comprising FIG. 11A and FIG. 11B, illustrates, in flow diagram form, a multi-carrier, multi-transmission embodiment of a method adapted for use in the embodiment set forth in FIG. 3.

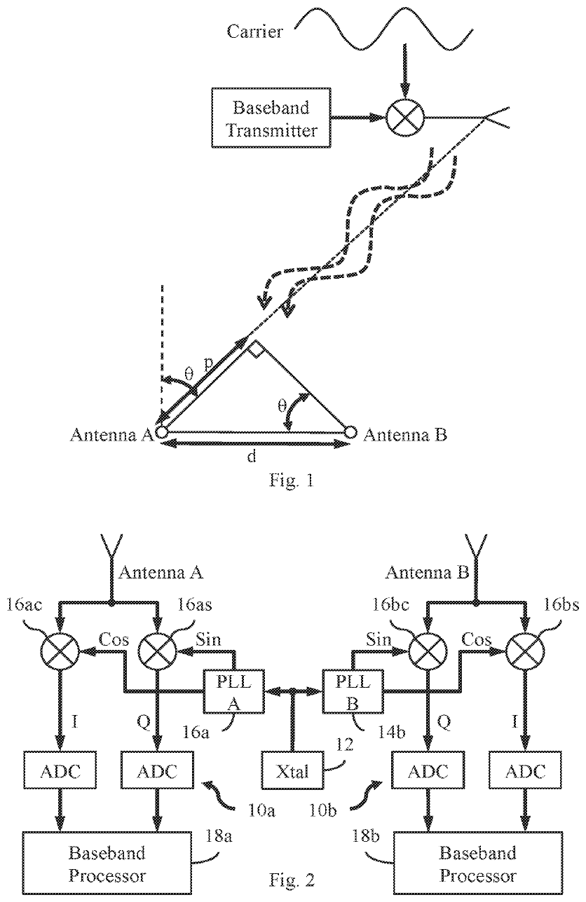

In the drawings, similar elements will be similarly numbered whenever possible. However, this practice is simply for convenience of reference and to avoid unnecessary proliferation of numbers and is not intended to imply or suggest that our invention requires identity in either function or structure in the several embodiments.

### DETAILED DESCRIPTION

We have discovered that it is possible to get the Cartesian (x,y) location of a transmitter relative to a multi-antenna receiver directly from the range and the path difference without going through an intermediary step of calculating an angle of arrival. In accordance with our invention, the path difference can be determined either by using: the difference in the phase of a received frame at two of the antennas; the difference in time of arrivals of a received frame at two of the antennas; or the difference in ranges measured to two of the antennas. Further, our method can be implemented in an RF system comprising: multiple receivers, each with a respective antenna; a single receiver having multiple antennas; or any combination thereof.

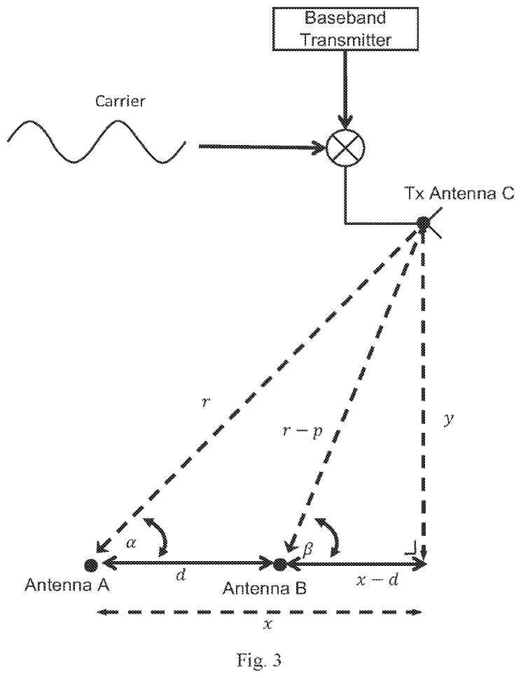

In the example illustrated in FIG. 3, the geometric distance between antenna A and antenna B is known to be d; and the path difference between antenna A and antenna B is determined to be p. Using well known methods, we can determine the range, r, between antenna A and antenna C, e.g., by measuring the time of flight between A and C. Provided the d is less than or equal to one half the wavelength, λ, of the signal transmitted from antenna C, p will always be between

$$\frac{- λ}{2} and + \frac{λ}{2} .$$

We can now determine the (x, y) location of the transmitter relative to the receiver as follows:
using the cosine rule:

$$cos ( A ) = \frac{( {b}^{2} + {c}^{2} - {a}^{2} )}{2 bc} \qquad [ Eq . 7 ]$$

$$cos ( a ) = \frac{( {r}^{2} + {d}^{2} - {( r - p )}^{2} )}{2 r d} \qquad [ Eq . 8 ]$$

$$\frac{x}{r} = \frac{( {r}^{2} + {d}^{2} - {r}^{2} + 2 rp - p2}{2 r d} \qquad [ Eq . 9 ]$$

$$x = \frac{( {d}^{2} + 2 rp - {p}^{2} )}{2 d} \qquad [ Eq . 10 ]$$

$${r}^{2} = {x}^{2} + {y}^{2} \qquad [ Eq . 11 ]$$

$$y = \pm \sqrt{{r}^{2} - {x}^{2}} \qquad [ Eq . 12 ]$$

or, alternatively:

$$( {x}^{2} + {y}^{2} ) = {( \frac{( {d}^{2} + 2 rp - {p}^{2} )}{2 d} )}^{2} + {y}^{2} = {r}^{2} \qquad [ Eq . 13 ]$$

$${y}^{2} = {r}^{2} - {( \frac{( {d}^{2} + 2 rp - {p}^{2} )}{2 d} )}^{2} \qquad [ Eq . 14 ]$$

$$y = \pm \sqrt{\frac{( {d}^{2} - {p}^{2} ) ( {( 2 r - p )}^{2} - {d}^{2} )}{2 d}} \qquad [ Eq . 15 ]$$

$$y = \pm \sqrt{\frac{( {d}^{2} - {p}^{2} ) ( {4}^{2} - 4 rp + {p}^{2} - {d}^{2} )}{2 d}} \qquad [ Eq . 16 ]$$

$$y = \pm \sqrt{\frac{( 1 - {( \frac{p}{d} )}^{2} ) ( 4 {r}^{2} - 4 rp + {p}^{2} - {d}^{2} )}{2 d}} \qquad [ Eq . 17 ]$$

Note that we cannot tell if the y coordinate is positive or negative, so there is a front/back ambiguity.

We note that d is small compared to r so d² is very small compared to r² and can be neglected:

$$y \approx \pm \sqrt{\frac{( 1 - {( \frac{p}{d} )}^{2} ) ( 4 {r}^{2} - 4 rp + {p}^{2} )}{2}} \qquad [ Eq . 18 ]$$

$$y \approx \pm ( r - ( \frac{p}{2} ) ) \sqrt{1 - {( \frac{p}{d} )}^{2}} \qquad [ Eq . 19 ]$$

We have determined that the maximum error by using this approximation is 0.22 mm for a 6.5 GHz carrier and a receiver antenna separation of λ/2. So, using Eq. 10 and Eq. 12 or Eq. 10 and Eq. 19, we can calculate the (x, y) coordinates of the transmitter without calculating the angle of arrival. We just need to know:
r—the range to one of the antennas;
d— the distance between the two antennas; and
p— the path difference for the signal arriving at the two antennas.

One of the most accurate ways to get the path difference is to get the phase difference of arrival of the transmitted signal in fractions of a cycle, and then multiple by the wavelength. Another way is to get the time difference of arrival of the signal and multiply it by the speed of light. A third way is to get the difference in time of flight and multiply it by the speed of light.

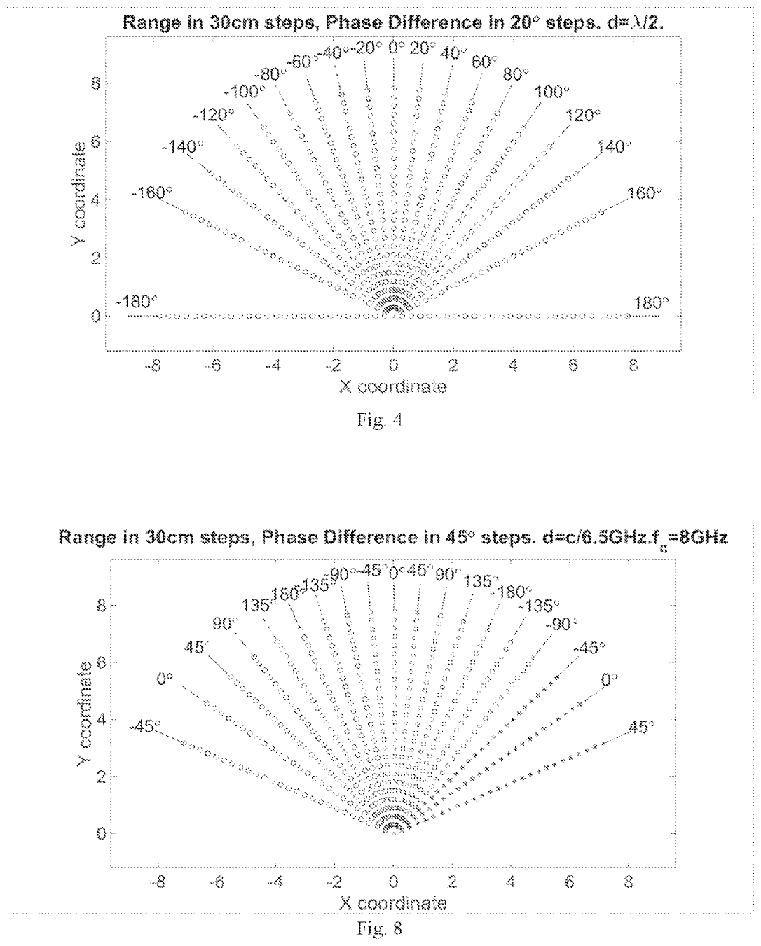

As can be seen in FIG. 4, however that the location uncertainty at phase differences near+/−180° is quite large. Thus, a very small change in phase gives a large change in the y position. We can see this sensitivity in Eq. 19, resulting from the

$$( 1 - {( \frac{p}{d} )}^{2} )$$

term under the radical. Accordingly, small errors due to noise at these larger phase differences are amplified compared to when the phase difference is in the +/−90° region. Also, extra care must be taken when calculating the square root in this region.

Consider, for example, the Taylor series for \sqrt{1−x²}:

$$1 - \frac{{x}^{2}}{x} - \frac{{x}^{4}}{8} - \frac{{x}^{6}}{16} - \frac{5 {x}^{8}}{128} - \frac{7 {x}^{10}}{256} - \frac{21 {x}^{12}}{1024} - \frac{33 {x}^{14}}{2048} - \frac{429 {x}^{16}}{32768} + 0 ( {x}^{18} )$$

Using 6 terms in this Taylor expansion, the calculation is accurate of to 2 cm and up to a phase difference of 140° and up to 5 cm up to 150°. Above 150°, however, the error increases rapidly. So, we will use a two-polynomial piece-wise approximation for the square root function:

function y=polysqrt(x);

pl=[107.81-33.530 4.91940 0.05019];

p2=[0.3557-0.9585 1.40389 0.20150];

yl=sum(pl·*x·\hat{ }[3 2 1O]);

y=sum(p2·*x·\hat{ }[3 2 1O]);

y(x<0.144)=yl(x<0.144);

y(x<0.002)=0;

end
Using this approximation gives a worst case error in the position of 2.4 cm within a 10 m radius, and an RMS error of 0.77 cm.

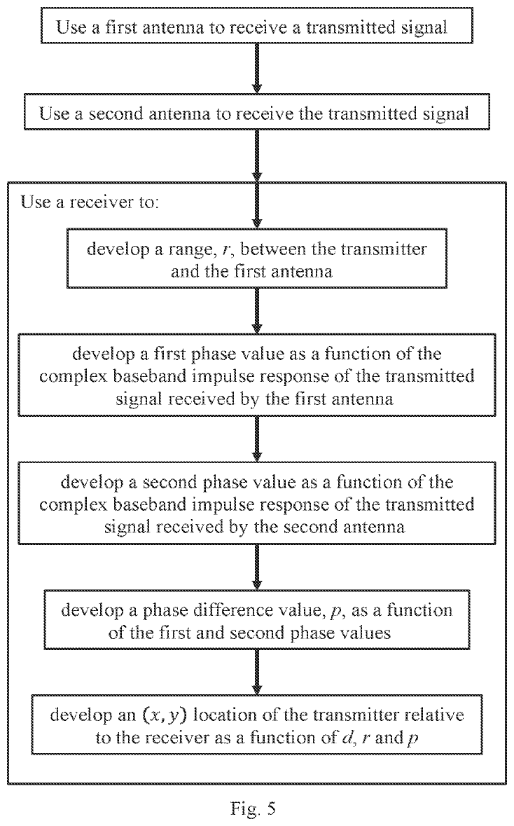

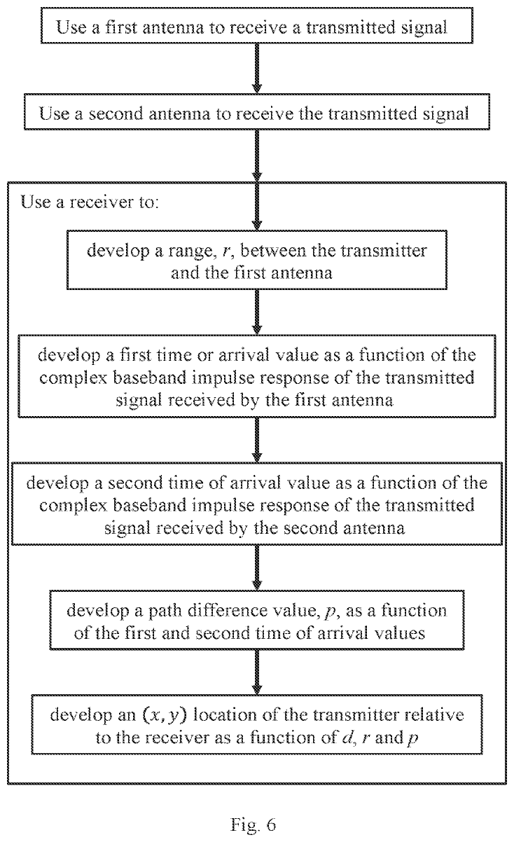

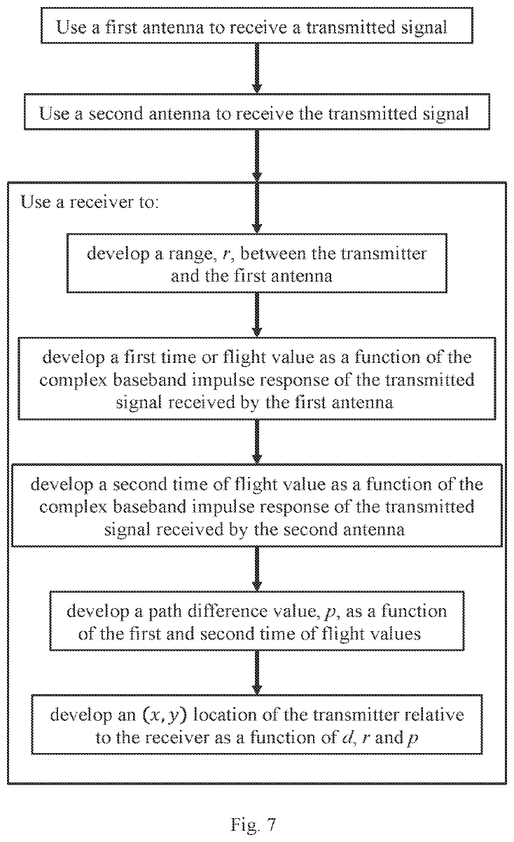

By the way of example, in FIG. 5, we have illustrated a phase difference embodiment of our method adapted for use in the embodiment illustrated in FIG. 3. Further, also by way of example, we have illustrated in FIG. 6 a time of arrival difference embodiment of our method adapted for use in the embodiment illustrated in FIG. 3. In FIG. 7, we have illustrated an example of a time of flight difference embodiment of our method adapted for use in the embodiment illustrated in FIG. 3.

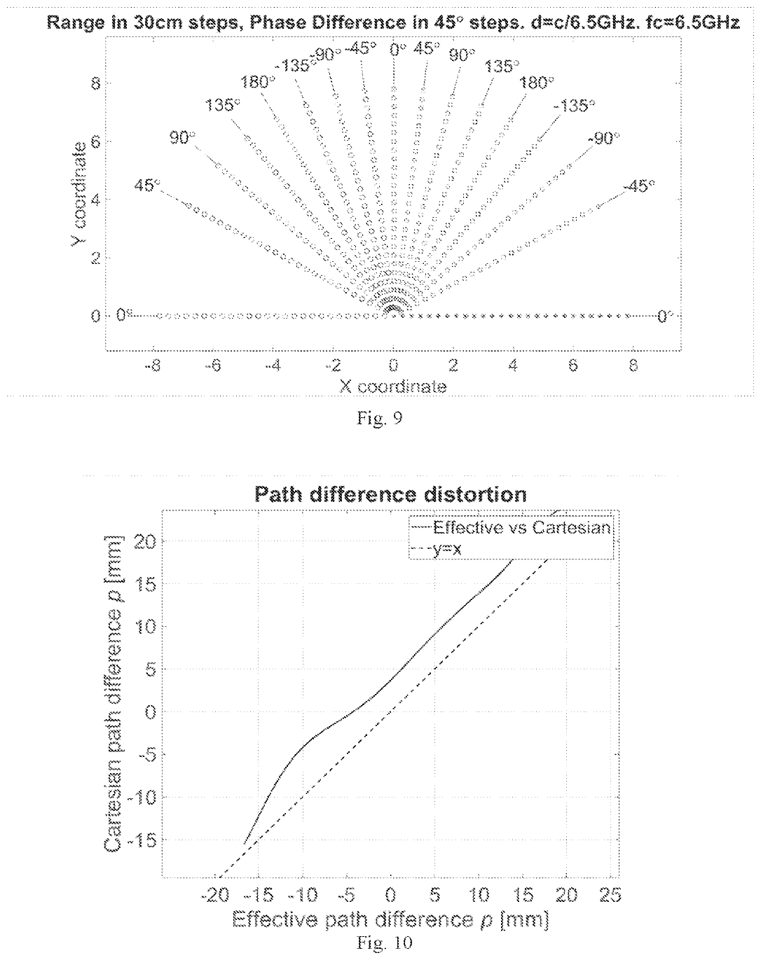

When the distance between the antennas is greater than half the wavelength of the center frequency, a particular phase difference can give more than one valid solution, because adding 360° will give the same phase difference. For instance, if the center frequency is 8 GHz and the distance between antennas is 1 wavelength of a 6.5 GHz carrier, we would have the situation shown in FIG. 9. In this case, apart from the 0° case, there are always two possible solutions for each phase difference. Fortunately, we can use this fact to our advantage. If the distance between the antennas is greater than one half wavelength, we can set the carrier frequency to one channel, and then measure the range and phase difference as before. This will give us more than one (x, y) coordinate—let us call this set of possible solutions Set 1. We then switch the carrier frequency to a different channel and repeat the measurement on the new channel. This will also give us multiple solutions—let us call this set of possible solutions Set 2. This will generally leave only one (x,y) coordinate. By way of example, in FIG. 11, we have illustrated one example of a multi-carrier, multi-transmission embodiment of our method adapted for use in the embodiment illustrated in FIG. 3.

In practice, noise perturbations in the phase measurement will almost always ensure that the corresponding solutions will not be exactly the same, so we must pick pairs of solutions, one from each set, which are closest to each other in the Euclidean sense. A well-known way to do this is to pick the (xᵢ, yᵢ) from Set 1 and the (xⱼ, yⱼ) from Set 2 that minimizes:

(xᵢ+xⱼ)²+(yᵢ−yⱼ)² [Eq. 20]

To get even better results, we can repeat this on a third (or even fourth or fifth) channel. For a third channel, we could pick the (xᵢ, yᵢ) from Set 1, (xⱼ, yⱼ) from Set 2, and the (xₖ, yₖ) from a Set 3 that minimizes:

(xᵢ−xⱼ)²+(xᵢ−xₖ)²+(xⱼ−xₖ)²+(yᵢ−yⱼ)²+(yᵢ−yₖ)²+(yⱼ−yₖ)² [Eq. 21]

Up to this point, we have assumed that the effective, i.e., measured, path difference is precisely equal to the Cartesian path difference. However, in a real system, the effective path difference and the Cartesian path difference will not be precisely equal. For example, when our two antennas are closer than a few wavelengths, the antennas interact through an effect known as mutual coupling. This causes the electromagnetic waves to behave differently than would be the case in a free space resulting in different effective and Cartesian path differences as a function of the path difference. Another effect seen in the real world is that the feed wires to the antennas can have slightly different lengths, or the paths from the down-mixer generator to the two separate down-mixers can have slightly different lengths. These two effects, and others, add a calculatable offset to the path difference.

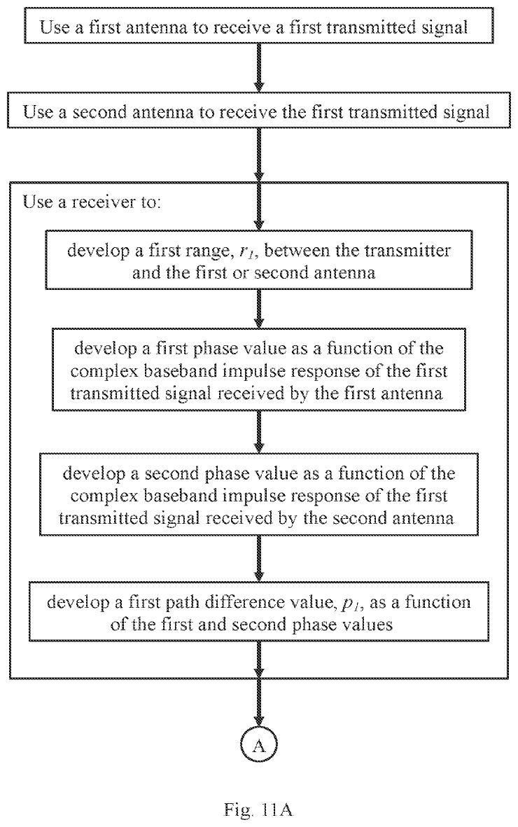

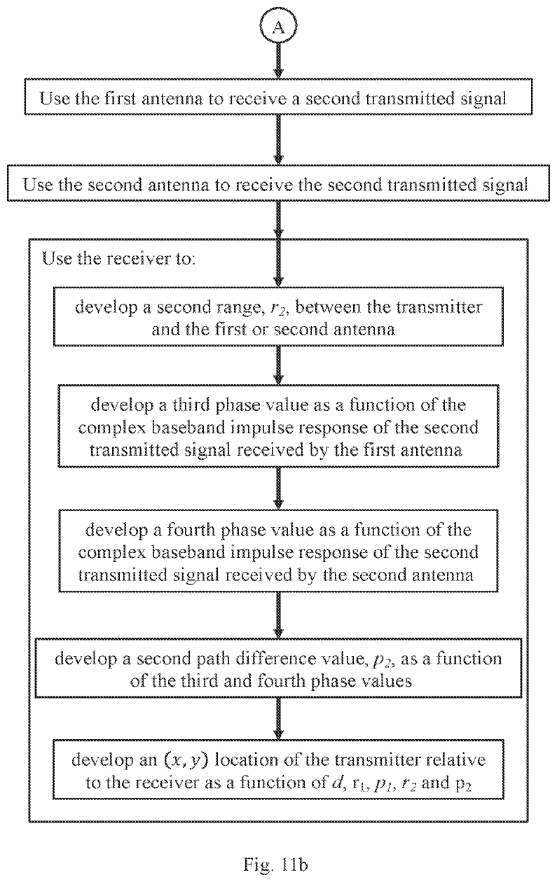

We propose to compensate for these cumulative effects by developing a Calibration Function between the effective and Cartesian path differences. In accordance with this embodiment, we first perform a system calibration process wherein a number of calibration measurements are taken, each from a different known (x,y) coordinate but, collectively, having a wide range of actual path differences. Since we know all of the (x, y) coordinates, we can calculate the respective expected path differences. By measuring the respective phase differences, we can also calculate the respective effective path differences. In this way, we can develop a suitable Calibration Function, e.g., in the form of a look-up table or as a piece-wise linear generator function or by using a polynomial fitting function. Then we can use this Calibration Function to correct the effective path difference, p, before applying the formulas to calculate the (x, y) coordinates. By way of example, in FIG. 10, we have illustrated one possible Calibration Function.

Although we have described our invention m the context of particular embodiments, one of ordinary skill in this art will readily realize that many modifications may be made in such embodiments to adapt either to specific implementations. For example, rather than calculating the path difference, p, one might directly determine the range, r₂, between the second antenna and the receiver using the same method used to determine the range, r₁, between the first antenna and the receiver. Further, the several elements described above may be adapted so as to be operable under either hardware or software control or some combination thereof, as is known in this art. Alternatively, the several methods of our invention as disclosed herein in the context of special purpose receiver apparatus may be embodied in computer readable code on a suitable non-transitory computer readable medium such that when a general or special purpose computer processor executes the computer readable code, the processor executes the respective method.

Thus, it is apparent that we have provided a method and apparatus for determining the location of a wireless transmission relative to a multi-antenna receiver. Although we have so far disclosed our invention only in the context of a packet-based UWB communication system, we appreciate that our invention is broadly applicable to other types of wireless communication systems, whether packed-based or otherwise, that perform channel sounding. Further, we submit that our invention provides performance generally comparable to the best prior art techniques but more efficiently than known implementations of such prior art techniques.

What is claimed is:

1. An ultra-wideband (UWB) transceiver, comprising:
a transmitter;
a receiver having a first antenna and a second antenna separated by a first distance, d;
a non-transitory computer readable medium configured to store computer executable instructions; and
one or more processors, wherein, in response to executing the computer executable instructions, the one or more processors are configured to perform a method comprising the steps of:
using the first antenna to receive a transmitted signal;
using the second antenna to receive the transmitted signal; and
using the receiver to:
develop a range, r, between the transmitter and a selected one of the first antenna and the second antenna;
develop a first time of flight value as a function of a complex baseband impulse response of the transmitted signal received by the first antenna;
develop a second time of flight value as a function of a complex baseband impulse response of the transmitted signal received by the second antenna;
develop a path difference value, p, as a function of the first time of flight value and the second time of flight value; and
develop an (x, y) location of the transmitter relative to the receiver as a function of d, r, and p.

2. The UWB transceiver of claim 1, wherein d is less than or equal to one half of a wavelength, A, of the transmitted signal.

3. The UWB transceiver of claim 1, wherein a processor is configured to develop the path difference value, p, as the function of a first phase value and a second phase value by developing the path difference value, p, as the function of the first time of flight value, the second time of flight value, and of a selected calibration function.

4. An ultra-wideband (UWB) receiver, comprising:
a first antenna;
a second antenna separated by a first distance, d;
a non-transitory computer readable medium configured to store computer executable instructions; and
one or more processors, wherein, in response to executing the computer executable instructions, the one or more processors are configured to perform a method comprising the steps of:
using the first antenna to receive a transmitted signal;
using the second antenna to receive the transmitted signal; and
using a receiver to:
develop a range, r, between a transmitter and a selected one of the first antenna and the second antenna;
develop a first time of flight value as a function of a complex baseband impulse response of the transmitted signal received by the first antenna;
develop a second time of flight value as a function of a complex baseband impulse response of the transmitted signal received by the second antenna;
develop a path difference value, p, as a function of the first time of flight value and the second time of flight value; and
develop an (x, y) location of the transmitter relative to the receiver as a function of d, r, and p.

5. The UWB receiver of claim 4, wherein d is less than or equal to one half of a wavelength, λ, of the transmitted signal.

6. The UWB receiver of claim 5, wherein a processor is configured to develop the path difference value, p, as the function of a first phase value and a second phase value by developing the path difference value, p, as the function of the first time of flight value, the second time of flight value, and of a selected calibration function.

7. An ultra-wideband (UWB) transceiver, comprising:
a transmitter;
a receiver comprising a first antenna and a second antenna;
a non-transitory computer readable medium configured to store computer executable instructions; and
one or more processors, wherein, in response to executing the computer executable instructions, the one or more processors are configured to perform a method comprising the steps of:
developing a range between the transmitter of a transmitted signal and one of:
the first antenna of the receiver that received the transmitted signal; or
the second antenna of the receiver that received the transmitted signal;
developing a first phase value as a function of a complex baseband impulse response of the transmitted signal received at the first antenna;
developing a second phase value as a function of a complex baseband impulse response of the transmitted signal received at the second antenna;
developing a path difference value as a function of the first phase value and the second phase value; and
developing a location of the transmitter relative to the receiver as a function of the range, the path difference value, and a distance between the first antenna and the second antenna.

8. The UWB transceiver of claim 7, wherein a processor is further configured to:
receive the transmitted signal from the first antenna of the receiver; and
receive the transmitted signal from the second antenna of the receiver.

9. The UWB transceiver of claim 7, wherein the distance is less than or equal to one half of a wavelength of the transmitted signal.

10. The UWB transceiver of claim 7, wherein developing the path difference value as the function of the first phase value and the second phase value comprises developing the path difference value as a function of the first phase value and the second phase value and a calibration function.

11. An ultra-wideband (UWB) receiver, comprising:
a first antenna;
a second antenna;
a non-transitory computer readable medium configured to store computer executable instructions; and
one or more processors, wherein, in response to executing the computer executable instructions, the one or more processors are configured to perform a method comprising the steps of:
developing a range between a transmitter of a transmitted signal and one of:
the first antenna of a receiver that received the transmitted signal; or
the second antenna of the receiver that received the transmitted signal;
developing a first phase value as a function of a complex baseband impulse response of the transmitted signal received at the first antenna;
developing a second phase value as a function of a complex baseband impulse response of the transmitted signal received at the second antenna;
developing a path difference value as a function of the first phase value and the second phase value; and
developing a location of the transmitter relative to the receiver as a function of the range, the path difference value, and a distance between the first antenna and the second antenna.

12. The UWB receiver of claim 11, wherein a processor is further configured to:
receive the transmitted signal from the first antenna of the receiver; and
receive the transmitted signal from the second antenna of the receiver.

13. The UWB receiver of claim 12, wherein the distance is less than or equal to one half of a wavelength of the transmitted signal.

14. The UWB receiver of claim 11, wherein developing the path difference value as the function of the first phase value and the second phase value comprises developing the path difference value as a function of the first phase value and the second phase value and a calibration function.

15. An ultra-wideband (UWB) transceiver, comprising:
a transmitter;
a receiver comprising a first antenna and a second antenna, wherein the first antenna and the second antenna are separated by a first distance, d;
a non-transitory computer readable medium configured to store computer executable instructions; and
one or more processors, wherein, in response to executing the computer executable instructions, the one or more processors are configured to perform a method comprising the steps of:
using the first antenna to receive a transmitted signal;
using the second antenna to receive the transmitted signal; and
using the receiver to:
develop a range, r, between the transmitter and a selected one the first antenna and the second antenna;
develop a first value as a function of a complex baseband impulse response of the transmitted signal received by the first antenna;
develop a second value as a function of a complex baseband impulse response of the transmitted signal received by the second antenna;
develop a path difference value, p, as a function of the first value and the second value; and
develop an (x, y) location of the transmitter relative to the receiver as a function of d, r, and p.

16. The UWB transceiver of claim 15, wherein each of the first value and the second value is further characterized as a phase value.

17. The UWB transceiver of claim 15, wherein each of the first value and the second value is further characterized as a time of arrival value.

18. The UWB transceiver of claim 15, wherein each of the first and second values is further characterized as a time of flight value.

19. The UWB transceiver of claim 15, wherein each of the first value and the second value is a selected one of a phase value, a time of arrival value, and a time of flight value.

20. An ultra-wideband (UWB) receiver, comprising:
a first antenna;
a second antenna, wherein the first antenna and the second antenna are separated by a first distance, d;
a non-transitory computer readable medium configured to store computer executable instructions; and
one or more processors, wherein, in response to executing the computer executable instructions, the one or more processors are configured to perform a method comprising the steps of:
using the first antenna to receive a transmitted signal;
using the second antenna to receive the transmitted signal;
developing a range, r, between a transmitter and a selected one the first antenna and the second antenna;
developing a first value as a function of a complex baseband impulse response of the transmitted signal received by the first antenna;
developing a second value as a function of a complex baseband impulse response of the transmitted signal received by the second antenna;
developing a path difference value, p, as a function of the first value and the second value; and
developing an (x, y) location of the transmitter relative to a receiver as a function of d, r, and p.

21. The UWB transceiver of claim 20, wherein each of the first value and the second value is further characterized as a phase value.

22. The UWB transceiver of claim 20, wherein each of the first value and the second value is further characterized as a time of arrival value.

23. The UWB transceiver of claim 20, wherein each of the first value and the second value is further characterized as a time of flight value.

24. The UWB transceiver of claim 22, wherein each of the first value and the second value is a selected one of a phase value, a time of arrival value, and a time of flight value.
